(19) United States
(12) Patent Application Publication
(10) Pub. No.: US 2011/0258676 A1
(43) Pub. Date: Oct. 20, 2011

(54) Interactive Video Subscription Player

(76) Inventors: James A. Gaskins, III, St. Augustine, FL (US); John B. Forbes, Wilmington, NC (US); Dee D. McHenry, Reddick, FL (US); Edwin Henry Meyne, Jacksonville, FL (US)

(21) Appl. No.: 12/907,621

(22) Filed: Oct. 19, 2010

Related U.S. Application Data
(60) Provisional application No. 61/253,038, filed on Oct. 19, 2009.

(51) Int. Cl. H04N 7/173

(52) U.S. Cl. 725/112

(57) ABSTRACT

An interactive video subscription service is disclosed. The interactive video subscription service has a web based application. The web based application has a main transmission source, a secondary transmission source, and at least one tertiary transmission source. The main transmission source, the secondary transmission source and at least one tertiary transmission source has video and audio signals. Wherein the main transmission source is controllable by a broadcaster, and the web based application is viewable by a plurality of subscribers.

### CLAIM OF PRIORITY

This application claims priority of U.S. provisional application No. 61/253,038 filed on Oct. 19, 2009 and is included herein in its entirety by reference.

### COPYRIGHT NOTICE

A portion of the disclosure of this patent contains material that is subject to copyright protection. The copyright operator has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a video service and more specifically to an interactive video subscription service connecting a multitude of subscribers to a broadcaster interacting live with a subset of live video viewers/subscribers.

2. Description of Related Art

Video distribution to subscribers has evolved from the early stages of simple televisions to video on demand services. With early televisions, a single broadcast source was used to transmit a video and audio stream to a multitude of viewers/subscribers. The amount of information transmitted to the subscriber via the early televisions was limited due to the technological limitations of the transmission media. Over time, the amount of information able to be broadcasted from the single source increased enough to facilitate the enhancement of the video and audio to color and stereo.

Televisions are typically only capable of receiving information and not able to transmit information back upstream to the video host. With new television services being introduced, such as pay per view and video on demand, information needs to be sent from the subscriber back to the host. This was necessary in order to facilitate the real time interaction with the subscriber. In addition, live video streaming services have become more common.

However, the use of live streaming video services has not been applied to a multitude of Web-based subscribers allowing the subscribers to simultaneously see live, delayed or previously recorded interactive audio/video streams. The present invention describes a Web-based interactive video system that allows a multitude of online subscribers access to the live video and audio streams while allowing the subscription service to initiate interaction of a subset of the viewers with the main host.

### SUMMARY OF THE INVENTION

An interactive video subscription service is disclosed. The interactive video subscription service has a web based application. The web based application has a main transmission source, a secondary transmission source, and at least one tertiary transmission source. The main transmission source, the secondary transmission source and at least one tertiary transmission source has video and audio signals. Wherein the main transmission source is controllable by a broadcaster, and the web based application is viewable by a plurality of subscribers.

A method for broadcasting multiple video sources in a web based application is disclosed. The method has the step of providing the web based application, the web based application having a main transmission source controlled by a broadcaster, a secondary transmission source and at least one tertiary transmission source. The method also having the step of transmitting video and audio signals from the main transmission source to the secondary transmission source and to the least one tertiary transmission source. The method also viewing the main transmission source, the secondary transmission source and the least one tertiary transmission source by a multitude of paying subscribers.

### BRIEF DESCRIPTION OF THE DRAWINGS

FIG. 1 displays a home page for a video subscription service in accordance with one embodiment of the present invention.

FIG. 2 displays an aggregate network web menu and/or page for the video subscription service of FIG. 1 in accordance with another embodiment of the present invention.

FIG. 3 displays an individual network web page for the video subscription service of FIG. 1 in accordance with another embodiment of the present invention.

FIG. 4 displays a broadcaster's home web page in accordance with another aspect of the present invention.

FIG. 5 displays a broadcaster aggregate web page in accordance with another aspect of the present invention.

FIG. 6 displays an interactive video player in accordance with another aspect of the present invention.

FIG. 7 displays a web site flow chart outlining the inventive concepts of another aspect of the present invention.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting. Any reference to any celebrity or other person real or otherwise is done for illustrative purposes and does not imply any type of endorsement whatsoever.

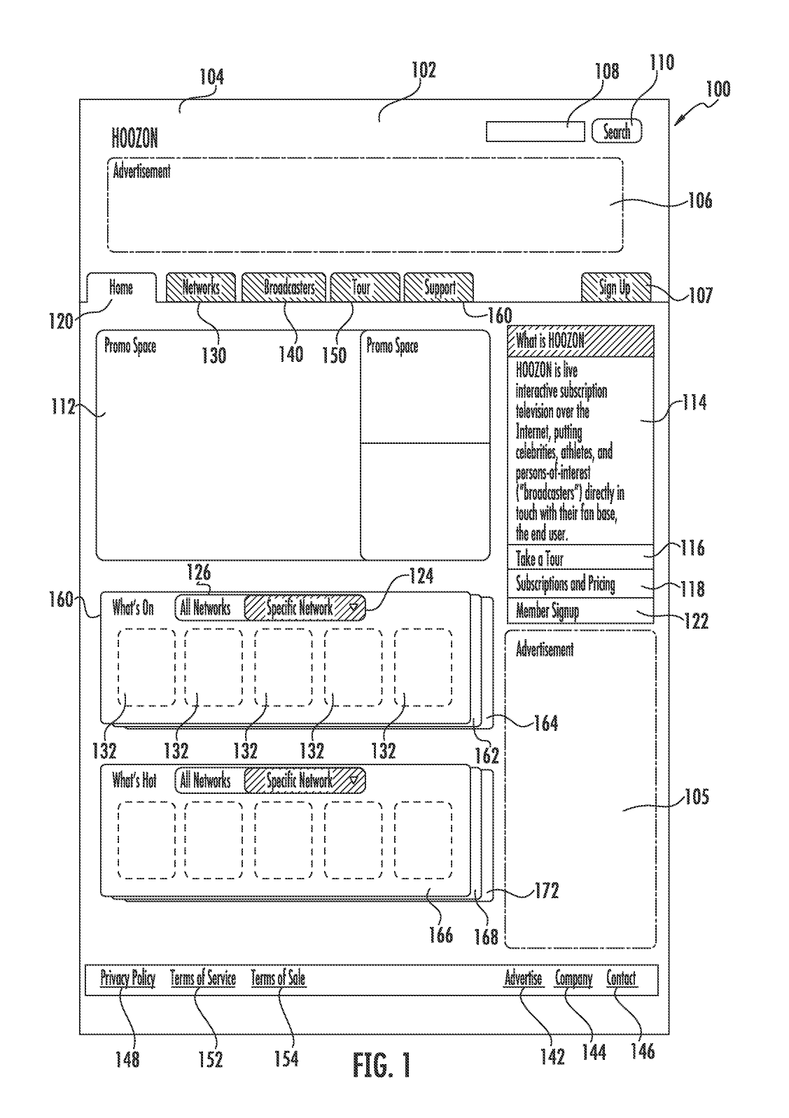

FIG. 1 displays a home web page 100 for facilitating the sale to subscribers of a streaming video service in accordance with one embodiment of the present invention. As is described in subsequent sections, the streaming video service may be used in conjunction with the various supporting web pages, allowing a live feed to be simultaneously broadcasted to an enormous number of subscribers. In one embodiment, the total number of subscribers would only be limited by the computing resources available. As those skilled in the art appreciate, the setting up of web pages with hyperlinks is well known in the art and is not discussed in great detail.

The home web page 100 may be divided into separate areas for ease of explanation. On the top of the home page 100 is a header 102. Part of the header 102 may contain a company identifier 104, advertisement area 106, search box 108 and search hyperlink 110. The company identifier 104 may state the name of the company hosting or owning the home web page 100. The advertisement area 106 may contain advertising material directing the viewer of the home web page 100 to hyper link to a particular advertiser of services or products. The operator of the home web page 100 may use the advertisement area 106 to generate recurring revenue, thus bolstering the business case of the home web page 100. The search box 108 and search hyperlink 110 may be used by the viewer of the web home page 100 to search for specific content in the various web pages under the control of the operator of the home web page 100.

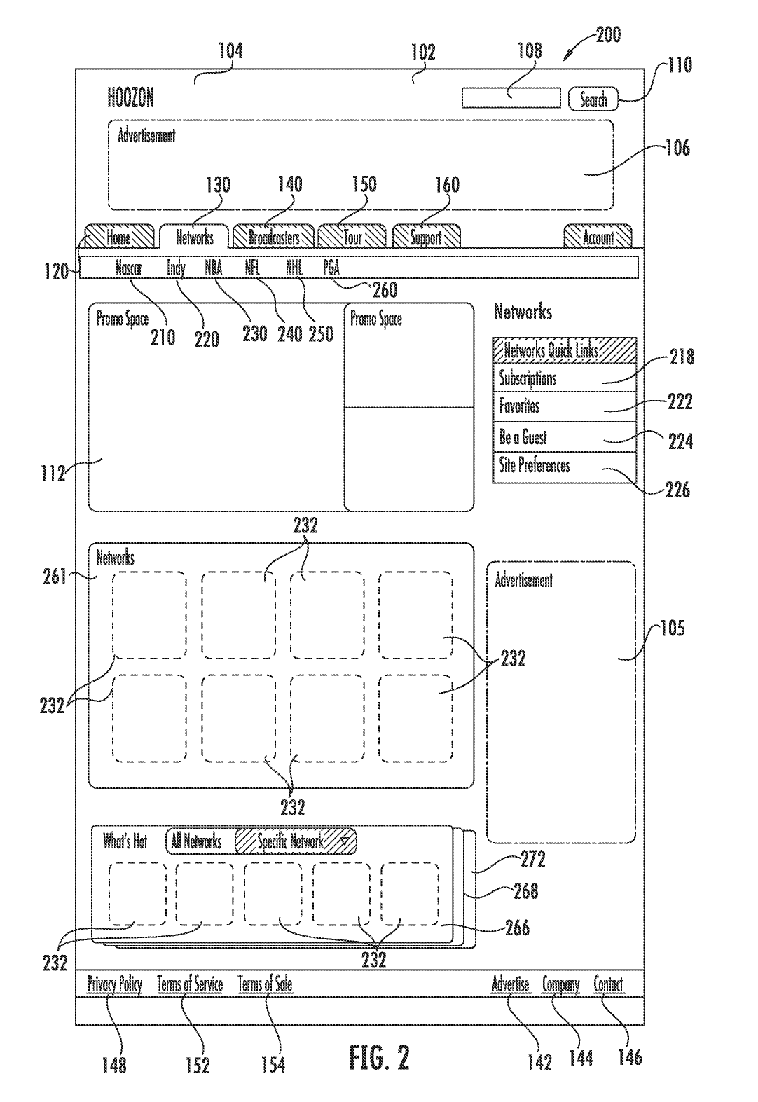

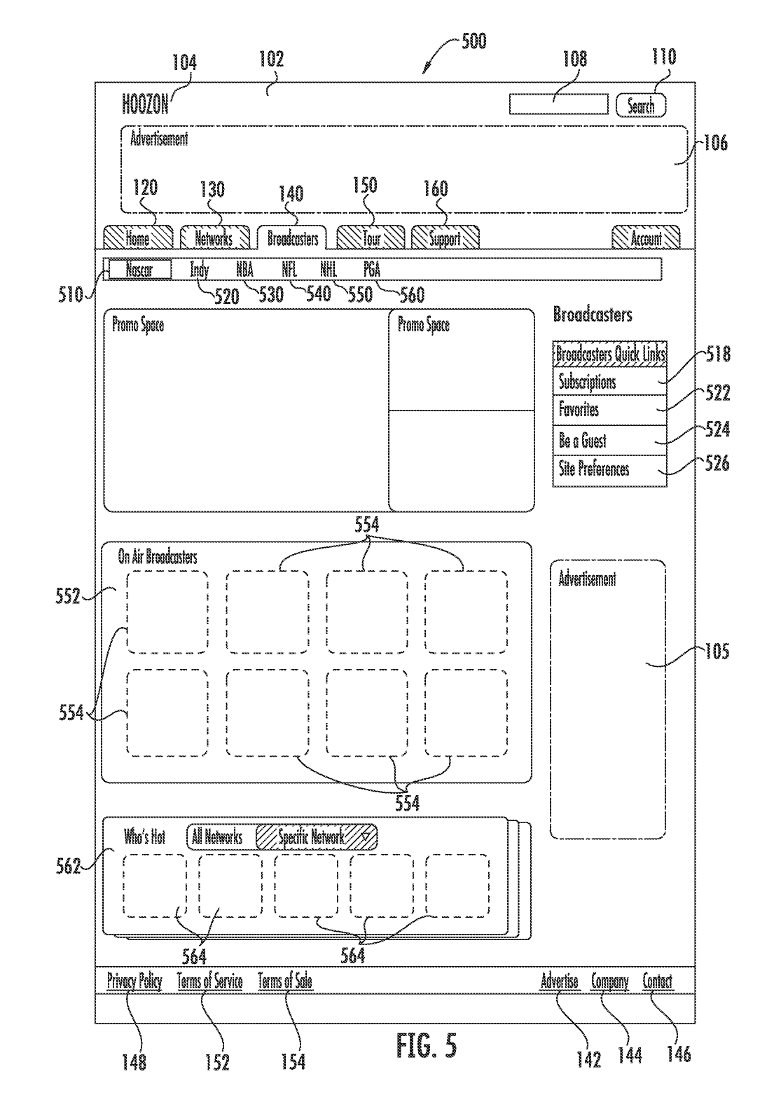

Under the advertisement area 106 are multiple tabs which may route the viewer to various other web pages below the home web page 100. Although the present description describes the various tabs on the home web page 100, these tabs would be viewable all throughout the various web pages, allowing the viewer to click on a particular tab which would route the viewer to the appropriate section. For example, the web home page 100 may contain a home tab 120, a networks tab 130, a broadcasters tab 140, a tour tab 150, and a support tab 160. Clicking on the home tab brings the viewer back to the home web page 100. Clicking on the networks tab would bring the viewer to a networks home web page 200 (see FIG. 2). Clicking on the broadcasters tab 140 directs the viewer to a broadcaster home web page 500 (See FIG. 5). Clicking on the tour tab 150 or support tab 160 will direct the viewer to the associated web pages.

In a middle section of the home web page 100 is a promotional area 112. The promotional area 112 may be used by the owner of the web home page 100 to promote various aspects of the streaming video player and broadcasters utilizing the service. For example, the operator of the web home page 100 may choose to promote a live interactive session between a nationally known race car driver and subscribers to the video service. In this example, the operator of the web home page 100 may show the likeness of the celebrity as well as additional information relating to the live interactive session.

Also, in the middle section of the web home page 100 is a company description area 114. The company description area may be used to provide the viewer information about the operator of the web home page 100. In addition, various hyperlinks may be positioned near the company description, such as a tour hyperlink 116, subscription and pricing hyperlink 118, and a sign up hyperlink 122. The tour hyperlink 116 may direct the viewer to a virtual tour of the website which may display an exemplary video stream as well as additional videos available to a subscriber. The subscription and pricing hyperlink 118 may direct the viewer to yet another web page (not shown for ease of illustration) containing pricing and subscription information. On this web page, the viewer may select the content and type of subscription that suites his or her viewing needs. The sign up hyperlink 122 may direct the viewer to the same web page as the sign up hyperlink 107 in the header 102.

Towards a bottom part of the home web page 100 is a preview section 160. Within the preview section, the viewer may select to preview video information from all networks by clicking on the all networks hyperlink 126. Alternatively, the viewer may find out specific information for a specific network by clicking on the drop down menu 124. Various video tiles 132 may then be displayed to viewer. Should the viewer want to activate a particular video feed identified by the video tiles 132, the viewer would click on the appropriate video tile 132 that displays the desired information. As can be seen in FIG. 1, there may be multiple preview sections, 162, 164, 166, 168, and 172 that the viewer may bring to the front in order to view specific information available on the preview sections.

On a footer section of the home web page 100 are hyperlinks to direct the viewer to other sections or web pages. For example, a privacy policy hyperlink 148 may direct the viewer towards the privacy policy enacted by the operator of the home web page 100. Another hyperlink in this area is the terms of service hyperlink 152. This link may direct the viewer to a description of the terms of service associated with using the web pages. Additionally, there may be a terms of sale hyperlink 154 which may direct the viewer towards the contractual terms and conditions associated with the sale of services over the web pages. Other hyperlinks include an advertise hyperlink 142, a company information hyperlink 144 and a contact information hyperlink 146.

FIG. 2 displays a network home web page 200 in accordance with another embodiment of the present invention. From the home web page 100 (of FIG. 1), the viewer would be directed to the network home page 200 by clicking on the network tab 130. After clicking on the network tab 130, the network home page 200 would be displayed. As can be seen in FIG. 2, the network home page 200 is similar to the home web page 100. On the top of the network home page 200 is a header 102. Part of the header 102 may contain a company identifier 104, advertisement area 106, search box 108 and search hyperlink 110. The search box 108 and search hyperlink 110 may be used by the viewer of the network home page 200 to search for specific content in the various related web pages. In addition, there is an advertisement box 105 that is positioned on the right side of the network home web page 200.

It is important to note that the present invention takes advantage of multiple sources of revenue streams. For example, the operator of the web based video based subscription player may collect subscription fees from web based subscribers. The subscription fee paid by the web subscribers would allow the web subscribers access to the various sections of the web based application. A base fee might be charged to allow the web subscriber to view one network and the associated web broadcasts within that network. A mid-tier fee may allow the web subscriber access to two networks and their associated broadcasts. An unlimited access fee may allow the web subscriber full unfettered access to all of the web sites.

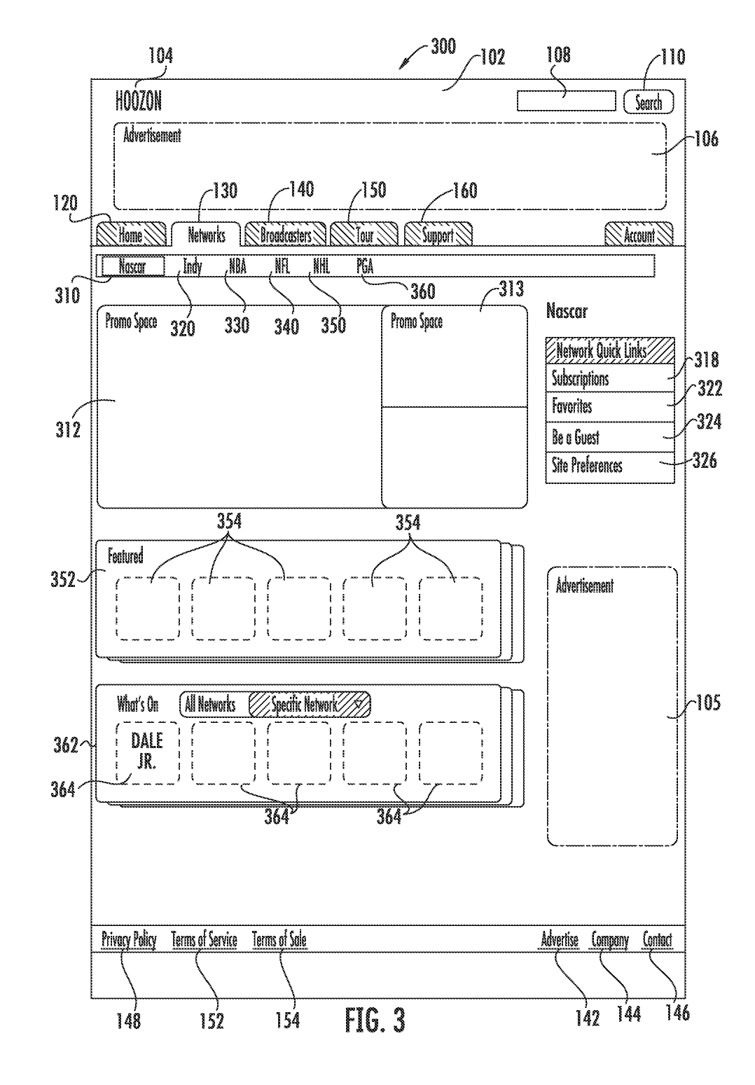

Other revenue streams that may be applied to the web based video subscription player may be advertisement. For example, Goodyear may choose to run tire advertisements when the viewer is on the NASCAR® home web page 300 (FIG. 3). Alternatively, Nike® may choose to run an advertisement when the PGA® home web page is displayed. These advertisements may be shown in the advertising spaces 105 and 106. Although the advertising spaces are shown as similar from web page to web page, they may be completely different advertisements. Although the present invention is described as it relates to sports and the various types and personalities associated with sports, the inventive concepts of the present invention could be applied to other applications such as other types of entertainment/human interest sectors and related personalities including but not limited to cooking, home improvement, movies, music, books, politics, religion, and the like.

Under the header 102 are the multiple tabs which may route the viewer to various other web pages located below the home web page 100. Similar to the web home page 100, the network home page 200 may contain a home tab 120, a network tab 130, a broadcaster's tab 140, a tour tab 150, and a support tab 160. Since the network home page 200 is active in FIG. 2, the network tab 130 may be highlighted. Subsequently, with the network tab highlighted, additional sub tabs may be displayed.

As shown in FIG. 2, the sub tabs may include, but not be limited to, a NASCAR tab 210, an “Indy” tab 220, an NBA® tab 230, an NFL® tab 240, and a PGA tab 260. As is described in relation to FIG. 3, when the viewer clicks on the NASCAR tab, the viewer will be directed to an individual network web page 300 which may contain information specifically related to NASCAR® and the various NASCAR broadcasters utilizing the service. Similarly, clicking on the other sub tabs, Indy tab 220, the NBA tab 230, the NFL tab 240, and the PGA tab 260 will direct the viewer to the specific home web page for those specific sports areas. Although the specific sports home web pages are not shown for ease of illustration, they may be similar in appearance to the NASCAR home web page 300 of FIG. 3.

Towards the right side of the network home page 200 (of FIG. 2) may be network quick links such as a subscription hyperlink 218, a favorites hyperlink 222, a guest hyperlink 224 and a site preferences hyperlink 226. The subscription hyperlink 218 may direct the viewer to a web page where the viewer may find more information on how to subscribe to the various services. The favorites hyperlink 222 may direct the viewer to a web page showing the viewer a predefined list of favorite tabs. Alternatively, the favorites hyperlink 222 may direct the viewer to the user's most-frequently viewed broadcasts. The guest hyper link 224 may direct the viewer to a web page allowing the viewer to temporarily sign up for certain services and features. The site preferences hyperlink 226 may direct the viewer to a web page where the viewer is able to select certain aspects of his subscription service.

Also seen in FIG. 2 is a network display section 261. Within the network display section 261 are “thumbnails” 232. The thumbnails may display video streams or still pictures showing the viewer the available sources of video. In one embodiment of the present invention, the thumbnails 232 may scroll across the network display section 261. In another embodiment, when the viewer places the mouse on top of the thumbnails 232, the thumbnails 232 may stop scrolling. This would allow the viewer to select a particular thumbnail 232 that he/she would like to investigate. The thumbnail 232 would also be associated with a hyperlink that would either take the viewer to the broadcaster's personal home page or alternatively to a network specific home page. For example, if a famous baseball player's picture was a thumbnail 232 and the viewer clicked on the specific thumbnail 232, the viewer would be directed either to the baseball player's home web page or to the baseball network home page (not shown for ease of illustration).

Towards the bottom of the network home web page 200 is an additional set of thumbnails 232 in a display section 268. The display section may display thumbnails 232 that may be considered “hot” by the operator of the web based subscription service. These may be thumbnails 232 that have been the most active over the past 24, 48, 72 or more hours. For example, if a previously recorded interview with a particular broadcaster was available on a Video On Demand (VOD) basis and had been viewed by 20,000 subscribers in the last 72 hours, the associated thumbnail for this interview may be shown here. The viewer may have the option to navigate to other display sections 268, or 272 which may have additional thumbnails 232 or may be for specific networks.

On a footer section of the networks home web page 200 are hyperlinks to direct the viewer to other sections or web pages. For example, a privacy policy hyperlink 148 may direct the viewer towards the privacy policy enacted by the operator of the home web page 100. Another hyperlink in this area is the terms of service hyperlink 152. This link may direct the viewer to a description of the terms of service associated with using the web pages. Additionally, there may be a terms of sale hyperlink 154 which may direct the viewer towards the contractual terms and conditions associated with the sale of services over the web pages. Other hyperlinks may include an advertise hyperlink 142, a company information hyperlink 144 and a contact information hyperlink 146.

If the viewer should click on the NASCAR hyperlink 210 or one of the thumbnails 232, the viewer may be directed to the NASCAR home page 300 as shown in FIG. 3. Similar to the home web page 100, the NASCAR web page 300 may have a header 102. Part of the header 102 may contain the company identifier 104, advertisement area 106, search box 108 and search hyperlink 110. The company identifier 104 may state the name of the company hosting or owning the web based subscription service.

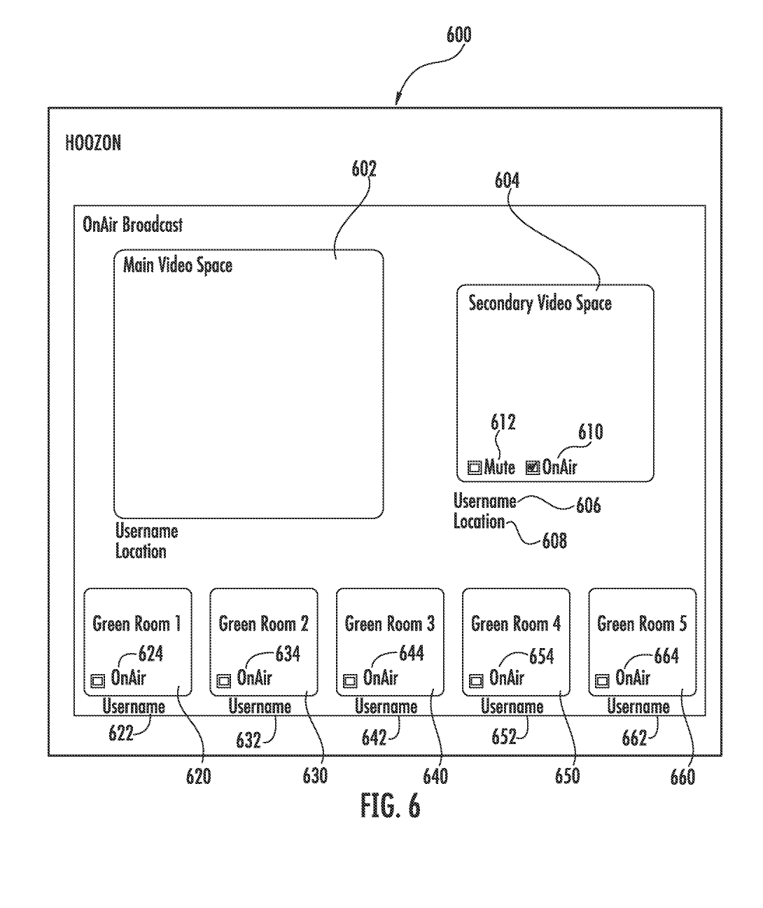

Under the advertisement area 106 are multiple tabs which may route the viewer to various other web pages. As mentioned previously, these various tabs may be viewable all throughout the various sub web pages. Clicking on the home tab may bring the viewer back to the home web page 100. Clicking on the networks tab may bring the viewer back up to the networks web page 200 (see FIG. 2). Clicking on the broadcasters tab 140 may direct the viewer to an aggregate broadcaster web page (not shown for ease of illustration) and so forth. For ease of explanation, a broadcaster is defined as a celebrity or other person who may be the subject of the main video and audio transmission, which is the main transmission source 602 of the web based video subscription player 600 of FIG. 6 or other videos which may be pre-recorded.

In a middle section of the NASCAR web page 300 may be a promotional space 313. The promotional space 313 may be used by the owner or operator of the web based subscription service to promote various aspects of the streaming video player and broadcasters utilizing the service. For example, the owner or operator of the web based subscription service may choose to promote a live interactive session between a nationally known race car driver and paid subscribers to the video service. In this example, the owner or operator may show the likeness of the broadcaster in the promotional space 313 as well as display additional information relating to the live interactive session. The likeness may also be associated with a hyperlink allowing the viewer to be routed directly to the specific live interactive session.

On the right side of the NASCAR home page 300 may be quick links similar to the quick links displayed on the previously discussed web pages. A subscription hyperlink 318 and a favorites hyperlink 322, a guest hyperlink 324 and a site preferences hyperlink 326 are shown. The subscription hyperlink 318 may direct the viewer to yet another web page (not shown for ease of illustration) containing pricing and subscription information. On this web page, the viewer may select the content and type of subscription that suites his or her viewing needs. The favorites hyperlink 322 may direct the viewer a web page that is customized to the viewer's liking. The guest hyperlink 324 may direct the viewer to another web page where the viewer may be shown demonstration videos.

Also seen in FIG. 3 is a featured display section 352. Within the featured display section 352 are thumbnails 354. The thumbnails 354 may display video streams or still pictures showing the viewer the available sources of video available. In one embodiment of the present invention, the thumbnails 354 may scroll across the featured display section 352. In another embodiment, when the viewer places the mouse on top of the thumbnails 354, the thumbnails 354 may stop scrolling. This would allow the viewer to select a particular thumbnail 354 that he/she would like to investigate. The thumbnail 354 may also be associated with a hyperlink that would either take the viewer to the broadcaster's personal home page or alternatively to a network specific home page. In one embodiment, the featured display section may have preview information on upcoming events.

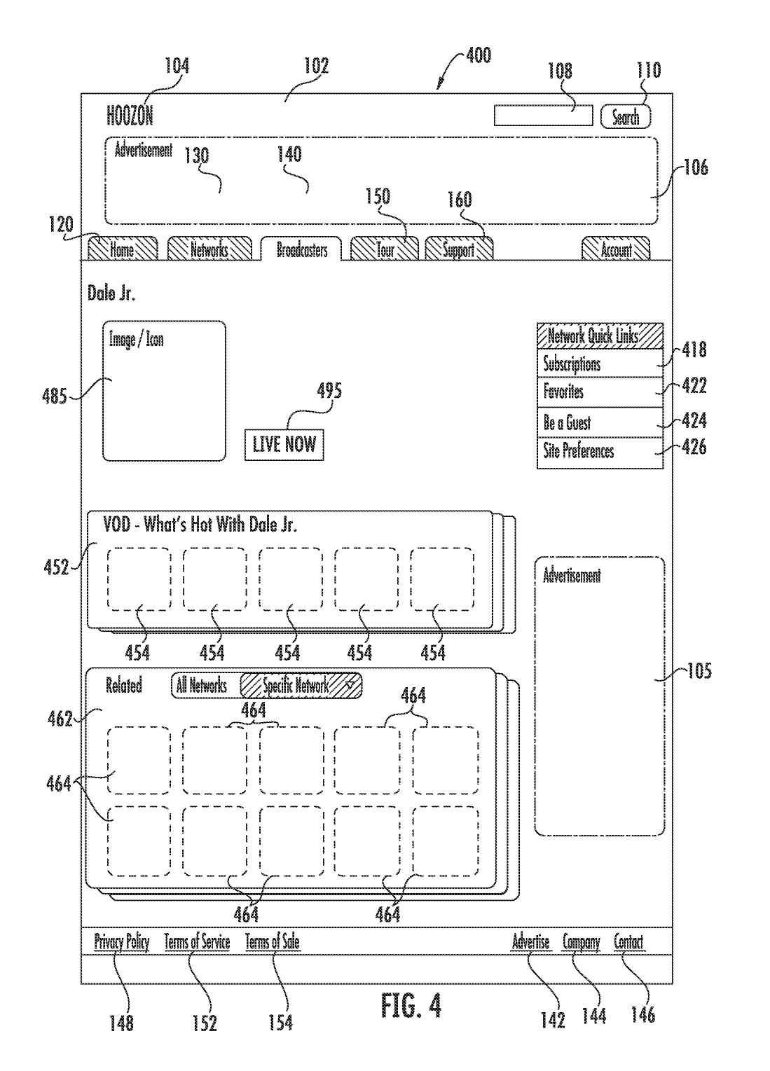

Below the featured display section 352 may be a “What's On” display section 362 having thumbnails 364. In one exemplary embodiment, the thumbnails 364 may correspond to the NASCAR drivers or personalities who may be on line and available for chatting. As shown in FIG. 3, a thumbnail 364 labeled “Dale Jr.” is shown. When the viewer clicks on this thumbnail, a hyperlink to the broadcaster's personal web page might be activated and the viewer may be directed to that personal web site. One exemplary broadcaster home web page 400 is shown in FIG. 4.

On a footer section of the NASCAR home web page 300 are hyperlinks to direct the viewer to other sections or web pages. For example, a privacy policy hyperlink 148 may direct the viewer towards the privacy policy enacted by the operator of the home web page 100. Another hyperlink in this area is the terms of service hyperlink 152. This link may direct the viewer to a description of the terms of service associated with using the web pages. Additionally, there may be a terms of sale hyperlink 154 which may direct the viewer towards the contractual terms and conditions associated with the sale of services over the web pages. Other hyperlinks include an advertise hyperlink 142, a company information hyperlink 144 and a contact information hyperlink 146.

FIG. 5 displays a broadcaster aggregate web page 500 in accordance with another embodiment of the present invention. On the top of the broadcaster web page 500 is a header 102. Part of the header 102 may contain a company identifier 104, advertisement area 106, search box 108, and search hyperlink 110. The company identifier 104 may state the name of the company hosting or owning the video subscription service. The advertisement area 106 may contain advertising material directing the viewer to a hyper link advertising particular services or products. The operator of the broadcaster web page 500 may use the advertisement area 106 to generate recurring revenue, thus bolstering the business case of the video subscription service. The search box 108 and search hyperlink 110 may be used by the viewer to search for specific content in the various web pages under the control of the operator of the broadcaster web page 500.

Similar to the previously described web pages, under the advertisement area 106 are multiple tabs which may route the viewer to various other web pages below the broadcaster web page 500. Although the present description describes the various tabs on the broadcaster web page 500, these tabs would be viewable all throughout the various web pages, allowing the viewer to click on a particular tab which would route the viewer to the appropriate section. Clicking on the home tab 120 brings the viewer back to the home web page 100. Clicking on the networks tab 130 would bring the viewer to the networks web page 200 (see FIG. 2). Clicking on the tour tab 150 directs the viewer to a web page providing a guided tour of the subscription service (not shown for ease of illustration) and so forth. Additionally, as shown in FIG. 5, sub tabs may include, but not be limited to, a NASCAR® tab 510, an “Indy” tab 520, an NBA® tab 530, an NFL® tab 540, and a PGA® tab 560. As was described in relation to FIG. 3, when the viewer clicks on the NASCAR tab, the viewer will be directed to list of broadcasters associated with NASCAR utilizing the service.

In addition, various other hyperlinks may be on the broadcaster aggregate web page 500. There may be quick links similar to the quick links displayed on the previously discussed web pages. A subscription hyperlink 518 and a favorites hyperlink 522, a guest hyperlink 524 and a site preferences hyperlink 526 are shown. The subscription hyperlink 518 may direct the viewer to yet another web page (not shown for ease of illustration) containing pricing and subscription information. On this web page, the viewer may select the content and type of subscription that suites his or her viewing needs. The favorites hyperlink 522 may direct the viewer a web page that is customized to the viewer's liking. The guest hyperlink 524 may direct the viewer to another web page where the viewer may be shown demonstration videos. The site preferences link 526 may direct the viewer to a web page containing the preferences saved by the viewer.

Also shown in FIG. 5 is an On Air Broadcasters section 552. Within the On Air Broadcasters section 552 are thumbnails 554. In one exemplary embodiment, the thumbnails 554 may correspond to all the NASCAR drivers or personalities who may be on line and available for chatting. When the viewer clicks on one of the thumbnails 554, a hyperlink to the broadcaster's personal web page is activated and the viewer is directed to that personal web site, similar to the personal web site 400 in FIG. 4. Should the broadcaster be on line and available for chatting, the hyperlink may direct the subscriber to the interactive video subscription player. Alternatively, the display section 552 may have preview information on upcoming events.

Towards the bottom of the broadcaster aggregate web page 500 is an additional set of thumbnails 564 in a display section 562. The display section 562 may display thumbnails 564 that may be considered “hot” by the operator of the web based subscription service. These may be thumbnails 564 that have been the most active over the past 24, 48, 72 or more hours.

Referring back to FIG. 4, the broadcaster's home web page 400 may be divided into separate areas for ease of explanation. On the top of the personal web page 400 is a header 102. Part of the header 102 may contain a company identifier 104, advertisement area 106, search box 108, and search hyperlink 110. The company identifier 104 may state the name of the company hosting or owning the video subscription service. The advertisement area 106 may contain advertising material directing the viewer to a hyper link advertising a particular services or products. The operator of the broadcaster's home web page 400 may use the advertisement area 106 to generate recurring revenue, thus bolstering the business case of the video subscription service. The search box 108 and search hyperlink 110 may be used by the viewer to search for specific content in the various web pages under the control of the operator of the broadcaster's home web page 400.

Similar to the previously described web pages, under the advertisement area 106 are multiple tabs which may route the viewer to various other web pages below the broadcaster's home web page 400. Although the present description describes the various tabs on the broadcaster's home web page 400, these tabs may be viewable all throughout the various web pages, allowing the viewer to click on a particular tab which would route the viewer to the appropriate section. Clicking on the home tab 120 brings the viewer back to the home web page 100. Clicking on the networks tab would bring the viewer to a networks web page 200 (see FIG. 2). Clicking on the broadcasters tab 140 directs the viewer to an aggregate broadcaster web page 500 (see FIG. 5) and so forth.

Just below the tabs described above, may be a picture/image/icon 485 which may identify the broadcaster who is associated with the broadcaster's home web page 400. Just next to the image 485 may be a “Live Now” box 495 that may alert the subscriber that the broadcaster is currently having a live video session. For example, when the Live Now box 495 is blinking, it may have an associated hyper link that may direct the subscriber to an interactive video subscription player 600 (see FIG. 6). When the subscriber clicks on the Live Now hyperlink, when it is active, the subscriber will be directed to the interactive video subscription player 600.

Also in FIG. 4 is a VOD section 452. Within the VOD section 452 are thumbnails 454. The thumbnails 454 may display video streams or still pictures showing the viewer the available sources of video available for that particular broadcaster. In one embodiment of the present invention, the thumbnails 454 may scroll across the VOD section 452. In another embodiment, when the viewer places the mouse on top of the thumbnails 454, the thumbnails 454 may stop scrolling. This would allow the viewer to select a particular thumbnail 454 which may correspond to a pre-recorded video of the broadcaster that he/she would like to view. It is important to note that a only a subscriber who has paid for the particular service will be allowed to view the pre-recorded video sessions with the broadcaster. A viewer may be able to see the available videos as an enticement to change their subscription services to allow them to actively view the particular videos.

Below the VOD section 452 is a display section 462 having thumbnails 464. In one exemplary embodiment, the thumbnails 464 may correspond to the NASCAR drivers or personalities who may be on line and available for chatting. When the viewer clicks on one of the thumbnails 464, a hyperlink to the broadcaster's personal web page is activated and the viewer is directed to that personal web site, similar to the personal web site 400 in FIG. 4. Alternatively, the display section 462 may have preview information on upcoming events.

FIG. 6 displays an interactive video subscription player 600 in accordance with one embodiment of the present invention. The player 600 has a main transmission source 602, a secondary transmission source 604 and multiple tertiary transmission sources 620, 630, 640, 650, and 660. All transmission sources, contain both audio and video elements. The main transmission source 602 is controlled by a broadcaster. In one exemplary embodiment, the broadcaster may be the broadcaster who is profiled in the personal web page 400 on FIG. 4. In this embodiment, the broadcaster can control which of the other transmission sources he/she wants to interact with. For example, the secondary transmission source 604 may show Joe Smith from Atlanta, Ga. This information would be shown in the username 606 and the location 608. Joe Smith may be a subscriber who has paid a subscription fee and has been selected by the operator of the web site to be the first interaction with the broadcaster.

The operator of the web site may have administrators who prioritize the subscribers into a queue. In this example, the administrators may also monitor these subscribers who have been selected to participate in the interactive video session. The live video streams from all of the transmission sources may be time delayed by 30 seconds or so to help avoid inappropriate content from being shown to the viewers of the video player 600. In addition, should the administrators feel that a subscriber who has been queued up into the tertiary transmission sources be doing something that was distasteful or inappropriate, the administrators could “bounce” that subscriber from the player 600.

As can also be seen in FIG. 6, each of the tertiary transmission sources 620, 630 640, 650 and 660 have associated user names 622, 632, 642, 652, and 662 respectively. The broadcaster has the ability to move any of the tertiary transmission sources to the secondary transmission source 604 by simply clicking his/her mouse on the tertiary transmission source to select it and drag it to the secondary transmission source location 604. As shown in FIG. 6, the player 600 may be the player that is displayed to the broadcaster. In this example, the broadcaster has the ability to mute the secondary transmission source 604 by clicking on the mute button 612. In addition, the broadcaster may immediately terminate the broadcasting of the secondary transmission source by clicking the “OnAir” button 610. Alternatively, the broadcaster may activate any of the tertiary transmission sources 620, 630, 640, 650 or 660 by clicking the associated OnAir button 624, 634, 644, 654, 664 respectively.

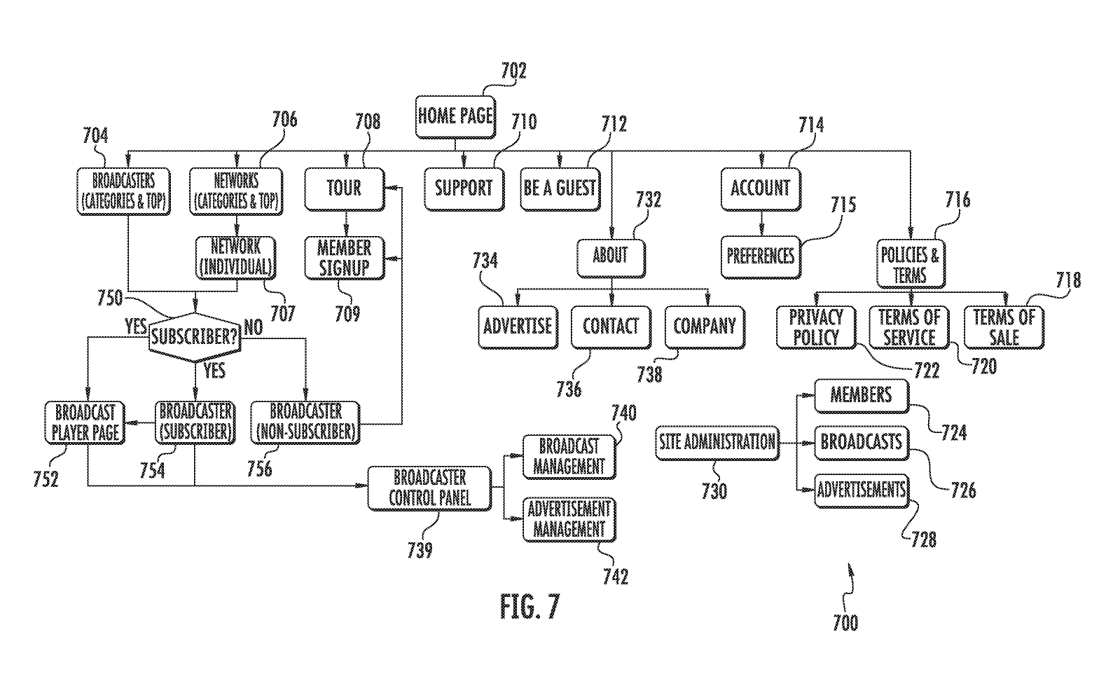

FIG. 7 displays a flow diagram 700 for the subscription service in accordance with one embodiment of the present invention. The various boxes within the flow chart 700 describe the flow that a viewer or subscriber may take when navigating the web site having the subscription service of the present invention. The flow diagram 700 starts at a home page box 702. From the home page box 702, the viewer has the choice to go to the broadcaster's home web page (box 704), the networks home web page (box 706), the tour web page (box 708), the support web page (box 710), the guest web page (box 712), the account web page (box 714) or the policies and terms web page (box 718).

From the Broadcaster's home web page (box 704) the viewer may be directed to different web pages based on if the viewer is a subscriber. If the viewer is not a subscriber, the viewer is determined to be a non-subscriber (box 754) and is routed to either the tour web page (box 708) or to the member sign up web page (box 709). If the viewer is a subscriber, the viewer will be directed to the broadcast player web page (box 752). If the viewer is a subscriber as well as a broadcaster as determined in box 754, the viewer will also be directed to the broadcast web page (box 752) but the broadcaster will have additional capabilities when directed to the broadcast player page. For ease of illustration, the broadcast player web page may also be referred to as the player 600 of FIG. 6. Continuing on, the broadcaster would have access to the broadcaster control page (box 739) where the broadcaster may be able to manage the actual broadcast (box 740) or manage his advertisements (box 742).

When the viewer is directed to the about web page (box 732), the viewer may be directed to either the advertisement web page (box 734), the contact web page (box 736), or information about the company web page (box 738). In the advertisement web page, the viewer may see information related to advertising rates to sponsor different ads on some of the web pages. Similarly, the contact web page may have contact information directing the viewer on the various ways to contact the operator of the video subscription service. The company web page may display information about the operator of the video subscription service.

Also shown in FIG. 7 is the site administration web page (box 730). The administrator of the subscription service may need to control the various functions within the subscription service. For example, the administrator may need to control the members (box 724), the actual broadcasts both live and pre-recorded (box 726), as well as the advertisements (box 728). The administrator may need to determine the level of subscription service the viewer has purchased and if that subscription service is still valid. As mentioned previously, the administrator may need to control the subscriber on an individual basis should the subscriber be shown as a live video feed in the video player 600.

If the viewer should choose to view the policies, terms and conditions of viewing and subscribing to the subscription service, the viewer would be directed to the terms web page (box 716). From this web page, the viewer may see the privacy policy (box 722), the terms and conditions related to the services provided with the subscription service (box 720) or the terms and conditions related to the sale of goods and services associated with the subscription service.

One advantage of the present invention website is a built-in application that serves as a platform that reduces development efforts and can be dynamically configured to meet immediate and future needs. The website's technology platform, for example, will enable broadcasters the opportunity to easily brand the appearance of their associated website within the web application. In addition, it will allow the broadcaster to effectively communicate with their fan base through one portal.

Illustrative Core Components of the website application associated with the present invention include but are not limited to:
1) Rich Media & Video: Media galleries are a core application that displays multiple types of files, images and videos in a meaningful and appropriate way. The operator of the website application may effortlessly integrate video from third-party services with ratings, commenting, and tagging functionality. Additionally, broadcasters may express their opinions and sort the various media (both video and audio) for relevancy.
2) Discoverability of Content: Tag clouds allow a viewer to browse information by topic and drill down into more focused content. RSS feeds based on key word search results keep viewers updated on their individual areas of interest while easily navigating through the web service application.
3) Robust Celebrity Profiles: Full-featured broadcaster profiles that include activity lists. This may include but not be limited to a ‘wall’ where broadcasters can post notes to fans/other broadcasters as well as an announcements ‘blog.’
4) Detailed Community Reporting & Analysis: Interactive data reporting will help the operator of the web based application to define the ROI for their online community.
5) Widgets: Extendable widget platform with pre-built widgets allowing the ability to quickly and easily build widgets in a standardized fashion that can also leverage outside data, to call a custom Web service, or to reuse an RSS feed.
6) Messaging & Social Streams: Ability to update online status so it is easy for broadcasters to communicate with individuals and with the community at large (including their friends on other social media networks as a viral strategy.)
7) Ease of Content Creation: Using the various embodiments of the present invention allow the operator of the web based application easy-to-use content management tools that allow the operator to organize content easily and reduce management costs.
8) Extensibility with Web Services: This consists of full-feature Web services (REST). API gives remote access to all data (i.e. posts, viewers, settings) which allows for easier extension of the platform and interoperability with external applications. (i.e. broadcaster can post to Facebook through the web based application).
9) Flexible UI (User Interface): Easily integrate Celebrity brands across their fan community with the flexible broadcaster user interface.
10) Localization of Content: Architecture is international friendly and gives the operator the option to publish sites in languages other than English (which is important for their global scalability goals).
11) Rich Security & Permissions Model: Offers a powerful permissions model which allows the operator to manage the role vs. the viewer, and provides a security framework that empowers the operator to determine how visitors will access various content.
12) Broadcaster Blogs: Blogs are robust, optimized for SEO, scalable, fast, and easy to use. The blogs application comes pre-integrated with tagging, comments, ratings, videos, viewer profiles, and RSS feeds.

The website application may utilize a Flash based Video Player/Transmitter which may provide the transmission sources associated with the interactive video subscription service in accordance with one embodiment of the present invention. The broadcaster may capture video on their home or laptop computer through a web cam or other video capture device creating a live video feed. The live video feed may be sent into the CDN (Content Delivery Network) and distributed to the subscribers' players via the CDN. However, it is important to note that a CDN is not required to practice the inventive concepts of the present invention. A single server could be used to interact with a few thousand viewers and subscribers. In order to reach a larger audience and potentially a global market, using a CDN allows the simultaneous broadcasting to a multitude of servers located throughout the world.

The Broadcaster will decide which Guest stream is OnAir or “live” (video and audio). If the Broadcaster makes a specific guest live, that stream is sent back to the CDN to be distributed to the Subscribers. The Video Player will be sent a message to pull an additional parallel stream to display the guest. The Broadcaster will be able to turn on and off streams at will using a simple and intuitive interface, and will have about a 5 second broadcasting delay to deal with compromising or disruptive behavior from their guests.

The broadcaster view may contain, but not be limited to:
1) View Own Video in Main Video Space. In this example, the broadcaster will have the ability to view his/her own video as it may be broadcasted out to the appropriate web telecast.
2) View On-Air Guest Video in Secondary Video Source. In this view, the broadcaster may have the ability to view the on-air guest that may be queued up to talk to the broadcaster. In this instance, the broadcaster may have the ability to mute the secondary audio source. In addition, the broadcaster may have the ability to go live with the secondary video source.
3) Additional Thumbnails (updating every 30 seconds or continuously fed live) of Guests that are in “Virtual Green Rooms”. The virtual green rooms are temporary holding locations where the administrator or broadcaster may position the guests while they are waiting in line to be connected with the broadcaster.

A Guest may be able to watch the Broadcaster, and may also be recording themselves on their web cam live. This stream will be sent to the CDN and tagged as a guest and tagged as “OnAir” or “Greenroom”. Guests will be selected prior to a live broadcast and configured before the beginning of a broadcast.

The guest view would be a video feed that is routed back to the guest that allows the guest to view:
1) The Broadcaster Video in Main Video Space
2) The Guest's own video in Secondary Video Space (if set as the current OnAir Guest). In addition, the Guest may be able to toggle the “OnAir Toggle Button,” allowing the Guest to take themselves “off air” and stop broadcasting.

As shown in FIG. 6, the interactive video subscription service 600 shows a subscriber view, which may allow the subscriber to view but not be limited to:
1) The Broadcaster in Main Video Space
2) The Guest in Secondary Video Space
3) Additional Thumbnails (updating every 30 seconds or continuously fed live) of Guests that are next in the queue (Virtual Green Rooms).

In one embodiment, the Broadcaster will decide which Guest stream is live (video and audio). If the Broadcaster makes a specific guest live, that stream is sent back to the CDN to be distributed to the Subscribers. The Video Player will be sent a message to pull an additional parallel stream to display the guest. The Broadcaster will be able to turn on and off the various streams at will by using a simple and intuitive interface, and in one embodiment will have a 5 second broadcasting delay to deal with compromising or disruptive behavior from their guests.

When the website and video player are deployed into the market place, the magnitude of memberships/subscriptions could be in the millions. It is important that the website architecture and the video player's technological foundation be proven, optimized, stable, and scalable. One cost effective (in terms of monetary cost and time to market) website architecture implementation may be to use an established content management solution (CMS) software solution as the technology platform's foundation that allows for customizations and extensibility. This technology solution may serve as a centralized hub in which all of its users would experience easy navigation and streamlined functionality throughout their visitation.

The website technology solution selected is considered the wave of the future in terms of page customization and development. Instead of a viewer needing to be completely versed in web design and its affiliated programs, this solution allows simple click and drag and instant customization features which are well aligned with typical requirements. As those skilled in the art may appreciate, some exemplary scalability and performance feature are listed as follows:

Designed for Clustering: This feature enables multiple web servers to run in parallel to serve requests. Known as clustering, this enables scalability to support millions of requests per month.

Proven Performance and Scalability: Powers some of the most well-known community sites (i.e. MySpace®) in the world and has been proven to easily handle over 350 million impressions/month.

ASP.NET Best Practices: Follows the recommended scalability and performance best practices for ASP.NET as specified by Microsoft.

Extensible Data Layer: Provides extensible database access layer that allows for easy extensibility.

Background Job Server: Enables distributed processing moving core tasks, such as content filtering, members sign-up, search, and more to dedicated servers.

Error Reporting and Logging Tools: Offers robust tools for reporting errors and logging which are built-in and give the community manager data on how the application is performing as well as logging all common incidents such as failed login attempts or new user sign-ups.

In order to support the previously described website and video player and an exemplary hosting solution with an exemplary video player, the servers hosting the website and video player may have the following hardware platform:
1) The entire perimeter may be protected by a FortiGate 3000 series of firewalls, providing IDS/IPS scanning and protection.
2) A Cisco Catalyst 4507R Layer 3 Switch may handle the network switching and routing. The Catalyst may be configured with dual redundant SUP II Plug engines with redundant 1300 W power supplies and multiple 48 port 10/100/1000 Mpbs switch modules. All servers and devices may plug directly into the Catalyst 4507R. A standby switch module may be in place.
3) Hardware configuration of particular servers varies.
4) Webfarm load balancing may be handled by a redundant pair of Foundry Networks hardware load balancers.

Domain name, mail, monitoring, backups and many other services may be configured in either a redundant or warm standby configurations.

What is claimed is:

1. An interactive video subscription service comprising:
a web based application, the web based application further comprising a main transmission source, a secondary transmission source, and at least one tertiary transmission source, the main transmission source, the secondary transmission source and the at least one tertiary transmission source further comprising video and audio signals,
wherein the main transmission source is controllable by a broadcaster, the web based application is viewable by a plurality of subscribers.

2. The interactive video subscription service of claim 1 further comprising a Content Delivery Network (CDN) wherein the CDN receives the main transmission source and retransmits the main transmission source to the plurality of subscribers.

3. The interactive video subscription service of claim 1 further comprising a Content Delivery Network (CDN) wherein the CDN receives the secondary transmission source and retransmits the secondary transmission source to the plurality of subscribers.

4. The interactive video subscription service of claim 1 further comprising a Content Delivery Network (CDN) wherein the CDN receives the at least one tertiary transmission source and retransmits the at least one tertiary transmission source to the plurality of subscribers.

5. The interactive video subscription service of claim 1 further comprising a user name and location identifier.

6. The interactive video subscription service of claim 5, wherein the user name and location identifier is associated with the main transmission source.

7. The interactive video subscription service of claim 5, wherein the user name and location identifier is associated with the secondary transmission source.

8. The interactive video subscription service of claim 5, wherein the user name and location identifier is associated with the at least one tertiary transmission source.

9. A method for broadcasting multiple video sources in a web based application, the method comprising:
providing the web based application, the web based application having a main transmission source controlled by a broadcaster, a secondary transmission source and at least one tertiary transmission source.
transmitting video and audio signals from the main transmission source to the secondary transmission source and to the least one tertiary transmission source.
viewing the main transmission source, the secondary transmission source and the least one tertiary transmission source by a multitude of paying subscribers.

10. The method of claim 9 wherein the broadcaster enables one of the at least one tertiary transmission sources to become the secondary transmission source.

11. The method of claim 9 further comprising the step of determining if the paying subscriber has paid for the viewing of the web based application.

12. The method of claim 11 further comprising the step of adding another transmission source to the at least one tertiary transmission source.

13. The method of claim 9 further comprising the step of aggregating the main transmission source to a CDN and broadcasting the aggregated transmission source to a plurality of subscribers.

14. The method of claim 9 further comprising the step of aggregating the secondary transmission source to a CDN and broadcasting the aggregated transmission source to a plurality of subscribers.

15. The method of claim 9 further comprising the step of aggregating the at least one tertiary transmission source to a CDN and broadcasting the aggregated transmission source to a plurality of subscribers.
